(19) United States
(12) Patent Application Publication
(10) Pub. No.: US 2006/0023748 A1
(43) Pub. Date: Feb. 2, 2006

(54) System for layering content for scheduled delivery in a data network

(76) Inventors: Ravinder Paul (Rob) Chandhok, Poway, CA (US); Vijayalakshmi R. Raveendran, San Diego, CA (US); Seyfullah Halit Oguz, San Diego, CA (US); Ben A. Saidi, San Diego, CA (US)

Correspondence Address: QUALCOMM, INC, 5775 MOREHOUSE DR., SAN DIEGO, CA, 92121, US

(21) Appl. No.: 11/158,662

(22) Filed: Jun. 21, 2005

Related U.S. Application Data
(60) Provisional application No. 60/586,820, filed on Jul. 9, 2004.

(51) Int. Cl. H04J 3/16

(52) U.S. Cl. 370/469

(57) ABSTRACT

System for layering content for scheduled delivery in a data network. A method is provided for transmitting content from a distribution server in a data network. The method includes encoding the content into a base layer and one or more enhancement layers, and transmitting the base layer. The method also includes receiving a request to receive one or more enhancement layers, and transmitting the one or more enhancement layers.

### CLAIM OF PRIORITY UNDER 35 U.S.C. §119

The present Application for Patent claims priority to Provisional Application No. 60/586,820 entitled “System for Layering Content for Scheduled Delivery in a DATA Network” filed Jul. 9, 2004, and assigned to the assignee hereof and hereby expressly incorporated by reference herein.

### BACKGROUND

I. Field

The present invention relates generally to the delivery of content (i.e., raw or compressed multimedia assets and other forms of digital information) in a network environment, and more particularly, to a system for layering content for scheduled delivery in a data network.

II. Description of the Related Art

Data networks, such as wireless communication networks or the wired Internet, have to trade off between services customized for a single terminal and services broadcast/multicast to a large number of terminals. An important problem to overcome for a number of existing and future applications is that of delivering content in a scalable and reliable manner to a large number of autonomous clients. For example, in one application, a network server transmits video/audio content to a number of network terminals, where the number of terminals could be on the order of hundreds or thousands. These terminals could be connected to the network via various wired and/or wireless radio link technologies.

In a data network, many types of information are strongly bound to time. They become available at a certain point in time, stay valid/up-to-date for a certain period of time, and then expire at a later time when an update is available. Some of the most common examples of information with this nature are news, weather broadcasts, and stock quotes. Any significant delay in the delivery of such time sensitive information to consumers reduces its value drastically and may even render it useless.

Consequently, for any electronic information distribution system, an important objective is the timely dissemination of information to the end-users (i.e. clients, consumers). This implies that a successful system design should enable rapid delivery of information upon its availability and as early as possible in its valid/up-to-date lifetime. Under the typical conditions of an information distribution system with limited resources (such as content storage-retrieval throughput capacity, transmission server capacity, delivery network/channel bandwidth, etc. and serving a large number of clients), achieving this goal becomes a real challenge. A further and significant complication arises from the additional requirement of simultaneously enabling a satisfactory—desirably pleasant—user experience. Obviously, a major component of a “good” user experience is the timely availability of the information for consumption. A failure in fulfilling this requirement is almost always unacceptable with a very small tolerance to unexpected delays. Since practically all information is available as multimedia content, in particular in audio-visual form, another significant component of the overall user experience is tied to the presentation quality of the content in these formats. From this perspective, at the most basic level, the information in its presented form should be easily intelligible without requiring any unreasonable effort from the end-user.

Unfortunately, conventional systems fail to provide this level of quality to a large number of receiving terminals in a bandwidth efficient manner. Furthermore, many types of receiving terminals have storage, power and processing constraints that may not be adequately addressed by conventional systems. For example, a large amount of content may be transmitted to a device utilizing bandwidth—a very valuable resource—in a shared transmission medium, the device's reception channel, storage and other device resources. However, if the device user decides not to view the content then the transmission of such a large amount of content has wasted valuable device and system resources.

Therefore, what is needed is a scalable content transmission system for transmitting content to a large number of receiving terminals in a data network. The transmission system must not only consider the deadline of the content but also transmission bandwidth efficiency, since the transmission may take place over precious air-link resources. In addition, the system should operate to provide the content to as many receiving terminals as possible given a fixed bandwidth communication channel. Additionally, the amount of bandwidth wasted on transmitting content to uninterested receivers should be minimized.

### SUMMARY

In one or more embodiments, a scalable transmission system is provided that operates to efficiently transmit content to one or more receiving terminals. The system provides a flexible framework to allow rate-distortion optimized packet scheduling. This framework is supported by pre-encoding content streams with appropriate packet dependencies, which may be adapted to the transmission channel (i.e., channel-adaptive packet dependency control). In one embodiment, the system operates to prioritize and partition coded content into predetermined groups or layers and time multiplex their scheduled delivery.

Thus, in one or more embodiments, the transmission system comprises a framework where scalable multimedia (audio, video, image, graphics) compression algorithms are utilized to increase the operational efficiency of a scheduled-unicasting (or scheduled-multicasting) based information distribution system. As a result, an increased number of end-users can be served without requiring additional system resources, and the percentage of wasted transmission bandwidth is reduced thereby increasing overall operational efficiency. Furthermore, these efficiency enhancements are achieved while maintaining an acceptable (essentially the original) presentation quality level for all users.

In one embodiment, a method is provided for transmitting content from a distribution server in a data network. The method comprises encoding the content into a base layer and one or more enhancement layers, and transmitting the base layer. The method also comprises receiving a request to receive one or more enhancement layers, and transmitting the one or more enhancement layers.

In one embodiment, apparatus is provided for transmitting content from a distribution server in a data network. The apparatus comprises processing logic that operates to encode the content into a base layer and one or more enhancement layers, and transmitting logic that operates to transmit the base layer. The apparatus also comprises receiving logic that operates to receive a request to receive one or more enhancement layers, and logic that operates to transmit the one or more enhancement layers.

In one embodiment, apparatus is provided for transmitting content from a distribution server in a data network. The apparatus comprises means for encoding the content into a base layer and one or more enhancement layers, and means for transmitting the base layer. The apparatus also comprises means for receiving a request to receive one or more enhancement layers, and means for transmitting the one or more enhancement layers.

In one embodiment, a computer-readable media is provided that comprises instructions, which when executed by processing logic in a distribution server, operate to transmit content in a data network. The computer-readable media comprises instructions for encoding the content into a base layer and one or more enhancement layers, and instructions for transmitting the base layer. The computer-readable media also comprises instructions for receiving a request to receive one or more enhancement layers, and instructions for transmitting the one or more enhancement layers.

In one embodiment, a method is provided for operating a receiving terminal to receive content transmitted in a data network. The method comprises receiving a content base layer, and determining that one or more enhancement layers are required to render the content with enhanced quality. The method also comprises transmitting a request to for one or more enhancement layers, and receiving the one or more enhancement layers. The method also comprises rendering the content using the base layer and the one or more enhancement layers to obtain the desired enhanced quality.

Other aspects, advantages, and features of the present invention will become apparent after review of the hereinafter set forth Brief Description of the Drawings, Detailed Description, and the Claims.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 shows a network that comprises one embodiment of a content transmission system;

FIG. 2 shows a functional block diagram of a server for use in one embodiment of a content transmission system;

FIG. 3 shows one embodiment of a method for operating the server of FIG. 2 in one embodiment of a content transmission system;

FIG. 4 shows a functional block diagram of a receiving terminal for use in one embodiment of a content transmission system; and

FIG. 5 shows one embodiment of a method for operating the receiving terminal of FIG. 4 in one embodiment of a content transmission system

### DETAILED DESCRIPTION

The following detailed description describes embodiments of a scalable content transmission system that operates to efficiently deliver content from a transmitting server to a large number of terminals. The system is suitable for use in any type of wired or wireless network, including but not limited to, communication networks, public networks, such as the Internet, private networks, such as virtual private networks (VPN), local area networks, wide area networks, long haul network, or any other type of data network.

In one or more embodiments, the transmission system operates to partition and encode content data into multiple content layers using scalable coding. Scalable coding (also known as “layered coding”) is the process of generating a compressed representation of content in the form of a hierarchical data structure, such that from this data structure multiple reconstructions of the content having varying spatial-temporal and/or signal (SNR) fidelity levels can be produced. The two major classes of partitions of the hierarchical data structure are called “base” and “enhancement” layers. The base layer is at the bottom of the hierarchy and is used for all reconstructions of the content. One or more enhancement layers make up the remaining levels of the hierarchy, and each enhancement layer is structured for a successive refinement of the reconstruction of the content, which is achieved by the combination of all layers below any point in the hierarchy (including the base layer).

The decoding of the base layer alone provides a basic level of reconstruction quality with respect to some signal attribute(s) of the content. If one or more enhancement layers are also decoded, then the reconstruction quality with respect to the pre-defined attribute(s) will be enhanced beyond what is achieved by decoding the base layer alone. In general, the reconstruction quality achieved is a function of the number of layers decoded. For example, in one embodiment, multimedia content in the form of raw audio, video or other forms of media information are encoded or transcoded (i.e., where the input encoding format is different from the output encoding format) to achieve compression and scalability. The output comprises multiple content layers of encoded data comprising one base layer and one or more enhancement layers that can be selectively transmitted to one or more receiving terminals where the content is then decoded and rendered.

In one or more embodiments, the transmission system operates to transmit some or all of the content layers to one or more receiving terminals in a process that allows each receiving terminal to determine the quality level of the content it receives. For example, each terminal receives the base layer and may optionally request one or more enhancement layers to obtain a desired quality level of the content. Thus, the system operates to provide each receiving terminal with the quality of service it desires, while maximizing network efficiency because the enhancement layers are transmitted to only those receiving terminals that have requested them.

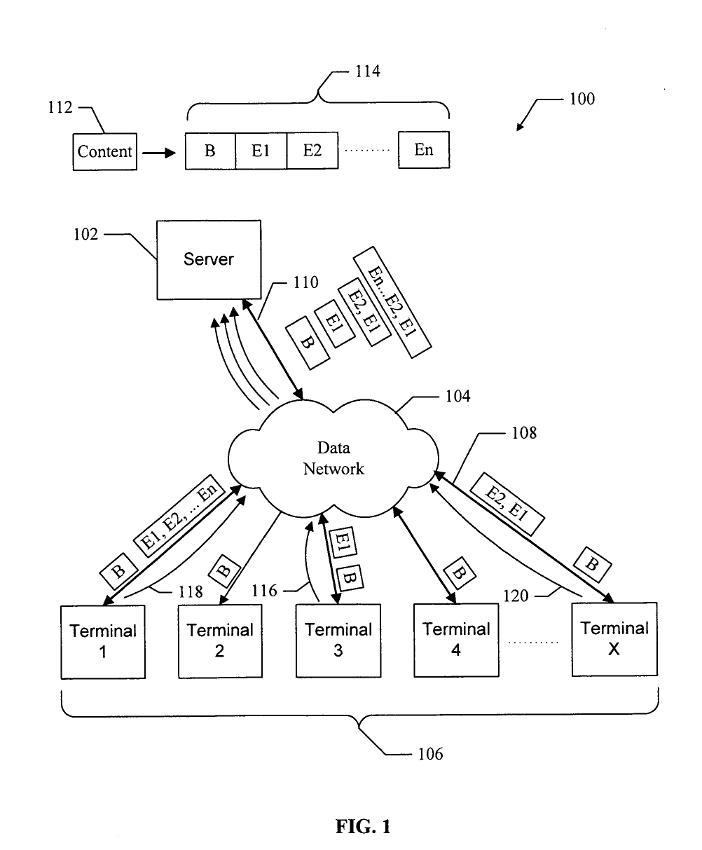

FIG. 1 shows a data network 100 that includes one embodiment of a content transmission system. The network 100 comprises a server 102, a data network 104, and terminals (1 thru X), as shown at 106. The data network 104 may be any type of wired or wireless network that allows data to be transmitted from the server 102 to the terminals 106. The terminals may be any type of receiving device that include, but are not limited to, portable telephones, handheld devices, notebook computers, desktop computers, or any other type of device capable of receiving network communications. The terminals communicate with the data network using communication channels 108, which may comprise wired or wireless communication links. For example, in one embodiment, the terminals are wireless telephones that communicate with the network 104 via wireless communication channels.

The server 102 operates to communicate with the data network via the communication channel 110, which may be any type of wired or wireless channel. In one embodiment, the server 102 includes content 112 that comprises any type of audio, video, or other multimedia content, or any other type of content file. The server 102 processes the content 112 using scalable coding techniques to produce hierarchical content layers 114. The content layers 114 comprise a base layer (B) and “n” enhancement layers (En). During operation, the server 102 transmits one or more of the content layers 114 to the receiving terminals so that the content received at each terminal may be rendered with a desired quality level. In one embodiment, the content layers are encrypted based on system requirements for digital rights management.

The server 102 operates to unicast or multicast the encoded content one or more layers at a time to the receiving terminals. The availability of the content in multiple prioritized (or priority) layers provides flexibility to scheduling algorithms that yield higher average throughput both in the network and on a per session basis.

In one embodiment, the server 102, transmits the base layer (B) to all receiving terminals (1-X). The base layer (B) allows each terminal to render the content with an acceptable quality level, and also allows each terminal to determine if additional quality is required.

After receiving the base layer, any of the terminals may send a request to the server 102 to receive one or more of the enhancement layers so that the content may be rendered with higher quality. For example, terminal 3 sends a request to the server 102 to request the first enhancement layer (E1), as shown by 116. In response to the request, the server 102 transmits the enhancement layer (E1) to the terminal 3. Similarly, terminals 1 and X also send requests to the server 102 to request enhancement layers, as shown at 118 and 120 respectively. The server 102 responds by transmitting enhancement layers E1 and E2 to terminal X, and by transmitting all enhancement layers to terminal 1.

After receiving the enhancement layers, the terminals 1, 3, X are able to render the content with higher quality than is possible with only the base layer B. The enhancement layers operate to improve the quality of audio, video, or other content characteristics. In one or more embodiments, the content layers function as follows.
Base layer Comprises compressed content data that meets the minimum service and/or performance requirements.
E1 layer Compressed data partition that enhances performance of the base layer service. The E1 enhancement layer could be downloaded prior to consumption and potentially stored based on a subscription. Examples of use of this service are for specialized features of a media delivery service system with or without associated rights management, such as preferred customer services.
E2 Layer Compressed data partition that enhances performance on top of the E1 layer and could be associated with optional preferences and associated rights management. Additionally, the E2 enhancement layer could enable progressive downloaded playback in streaming scenarios where this layer is delivered to the transmitting terminal during playback.
E3-En layers Compressed data partitions that enhance performance on top of the underlying E1 and E2 layers.

In one embodiment, encoded content layers are stored in a database and are available for the server 102 to schedule their delivery based on the lifetime of the content, network conditions, and/or as demanded by consumers. For example, the content is encoded by the server 102 or a third party and then stored in the database. In another embodiment, the encoded content layers are delivered to the server 102 for distribution.

In one embodiment, the number of enhancement layers generated can be a variable that depends on terminal capabilities, types of content to be delivered, and/or any other factors. Additionally, the number of enhancement layers that may be utilized by a particular receiving terminal depends on individual terminal capabilities, network (or channel) conditions, bandwidth availability, expected throughput, and/or any other factors.

It should be noted that the content transmission system of FIG. 1 represents just one embodiment, and that other embodiments are possible within the scope of the invention. For example, it is possible that the content 112 be encoded into the content layer 114 by another network entity, and that this entity then forwards the content layers 114 to the server 102 for transmission to the receiving terminals in accordance with the embodiments described herein. Thus, changes and additions to the system shown in FIG. 1 are possible within the scope of the embodiments.

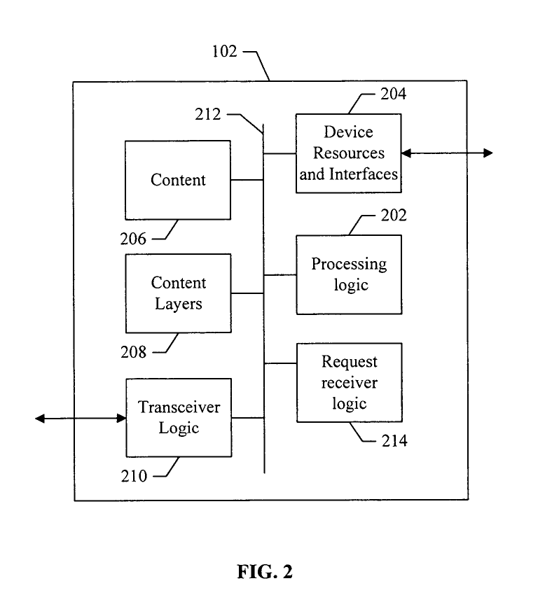

FIG. 2 shows a functional block diagram of the server 102 for use in one embodiment of a content transmission system. The server 102 comprises processing logic 202, device resources 204, content data 206, and transceiver logic 210, all coupled to an internal data bus 212. The server 102 also comprises a content layer database 208 and enhancement layer request receiver logic 214, which are also coupled to the data bus 212.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions. In one embodiment, the processing logic 202 also comprises encoding logic that is operable to encode content to produce one or more content layers.

The device resources and interfaces 204 comprise hardware and/or software that allow the server 102 to communicate with internal and external systems. For example, internal systems may include mass storage systems, memory, display driver, modem, or other internal device resources. The external systems may include user interface devices, printers, disk drives, or other local devices or systems.

The content data 206 represents content stored in a memory to be transmitted over a data network to one or more receiving terminals. For example, the content data 206 may comprise audio, video, or other multimedia content, applications, or data in any format that is stored on any type of memory device.

The transceiver logic 210 comprises hardware and/or software that operates to allow the server 102 to transmit and receive data and other information to/from external devices or systems. For example, the transceiver logic 210 may comprise logic to transmit data and/or other information over a data network to other devices, such as receiving terminals. For example, the server 102 may use the transceiver logic 210 to transmit any number of unicast or multicast transmissions over a data network to a plurality of receiving terminals.

The content layers database 208 comprises any combination of hardware and software that operates to provide the storage and retrieval of content layers. For example, in one embodiment, the processing logic 202 processes the content data 206 to produce content layers that are stored in the content database 208. In another embodiment, content layers are received at the server 102 via the transceiver logic 210 and stored in the content database 208. For example, the received content layers may be transmitted to the server 102 from a third-party content provider.

The enhancement layer request receiver logic 214 comprises any combination of hardware and software, and operates to receive enhancement layer requests transmitted from one or more receiving terminals. The requests are transmitted from terminals that wish to receive one or more content enhancement layers, thereby allowing the associated content to be rendered with higher quality than is possible with just a base layer. For example, in one embodiment, one or more receiving terminals transmit enhancement layer requests to the server 102 that are received at the transceiver logic 210 and forwarded to the request receiver logic 214. In response, the logic 214 retrieves the requested enhancement layers from the content database 208 and transmits the retrieved enhancement layers to the requesting terminals via the transceiver 210.

During operation of one embodiment of the server 102, the encoding logic of the processing logic 202 operates to process the content data 206 to produce encoded content layers. For example, any scalable encoding technique may be used to encode the content data to form the content layers. The following describes several scalable encoding techniques that may be performed by the processing logic 202 to produce the encoded content layers.

Scalable Encoding

In one or more embodiments, the system is suitable to scalably encode a wide variety of data files or other information into base and enhancement layers as described herein. Such data files include but are not limited to multimedia signals, such as video, audio, images and graphics information. The following sections provide a brief description of scalable video and audio encoding. However, it should be noted that the system is operable to scalably encode and transmit virtually any type of information signal.

Scalable Video Encoding

A brief list of video signal attributes most frequently utilized in the context of scalable coding is provided below.
Spatial Resolution Spatial scalability allows decoders to decode a subset (base plus zero or more enhancement layers) of the total bit-stream to reconstruct and display video data at different spatial resolutions i.e. frame sizes;
Temporal Resolution Temporal scalability allows decoders to decode a subset (base plus zero or more enhancement layers) of the total bit-stream to reconstruct and display video at different temporal resolutions i.e. frame rates;
Sample Fidelity Sample fidelity scalability allows decoders to decode a subset (base plus zero or more enhancement layers) of the total bit-stream to reconstruct and display video at different signal-to-noise ratio (SNR) levels;
Fidelity at video object level Object-based scalability allows decoders to decode a subset (base plus zero or more enhancement layers) of the total bit-stream to reconstruct and display video at different scene composition complexity levels with respect to the number of independent video objects simultaneously decoded and presented.
Chroma The chroma (color information for the video signal) subsampling pattern can also be utilized to generate a scalable bit-stream, although this approach is less common in practice.
Data Partitioning Data Partitioning is a very low complexity—compared to other scalable coding schemes—layered coding technique that is particularly well suited for prioritized transmission of compressed data. The Data Partitioning framework divides the bit-stream of a single-layer nonscalable codec into two (MPEG-2 Video and MPEG-4 Video) or three parts (H.264). The first part comprises the most critical information fields in the original bit-stream e.g. headers, quantization parameters, motion vectors and lower order DCT coefficients. The other parts contain the remaining less critical information e.g. higher order DCT coefficients.

It is important to note that in addition to the above introduced monolithic video scalability modes, a scalable bit-stream encoder can potentially combine the use of more than one scalability mode in generating a scalable representation such as the concurrent use of temporal and sample fidelity scalabilities. In this latter case and also in general, the different types of enhancement information can be provided in different enhancement layers or both (all) can be embedded into a single enhancement layer.

Scalable Audio Encoding

A brief list of audio signal attributes most frequently utilized in the context of scalable coding is provided below.
Sampling Rate Sampling rate scalability allows decoders to decode a subset (base plus zero or more enhancement layers) of the total bit-stream to reconstruct and play audio at different sampling rates.
Sample Fidelity Sample fidelity scalability allows decoders to decode a subset (base plus zero or more enhancement layers) of the total bit-stream to reconstruct and play audio at different signal-to-noise ratio (SNR) levels.
Bandwidth Bandwidth scalability allows decoders to decode a subset (base plus zero or more enhancement layers) of the total bit-stream to reconstruct and play audio at different spectral fidelities i.e. low-pass cutoff frequencies.
Channel Structure Scalability with respect to channel structure allows decoders to decode a subset (base plus zero or more enhancement layers) of the total bit-stream to reconstruct and play audio in different channel compositions i.e. mono versus stereo, or possibly higher channel numbers such as 5.1.
Data Partitioning In a manner analogous to its utilization for prioritized video coding, data partitioning can be applied to a single-layer non-scalable audio codec to achieve a simple layered representation for compressed audio data.

It is important to note that in addition to the above introduced monolithic audio scalability modes, a scalable bit-stream encoder can potentially combine the use of more than one scalability mode in generating a scalable representation such as the concurrent use of sample fidelity and bandwidth scalabilities. In this latter case and also in general, the different types of enhancement information can be provided in different enhancement layers or both (all) can be embedded into a single enhancement layer.

Alternate forms of processing as well as those similar to the ones cited above can be applied to video, audio and other forms of multimedia and generic digital information, to achieve layered representations for these data. In particular, spatial resolution, sample fidelity, object level fidelity, chroma format scalable encoding and data partitioning are immediately applicable to images and graphics. Utilization of all such layered representation schemes is within the scope of the current invention.

In one embodiment, after the content layers have been produced, the processing logic 202 controls the transceiver 210 to transmit the base layer to all receiving terminals. In one embodiment, the content transmission system comprises program instructions stored on a computer-readable media, which when executed by the processing logic 202, provides the functions of the server 102 described herein. For example, instructions may be loaded into the server 102 from a computer-readable media, such as a floppy disk, CDROM, memory card, FLASH memory device, RAM, ROM, or any other type of memory device or computer-readable media that interfaces to the server 102 via the device resources 204. In another embodiment, the instructions may be downloaded into the server 102 from a network resource that interfaces to the sever 102 via the transceiver logic 210. The instructions are stored in a computer-readable media at the processing logic 202, and when executed by the processing logic 202, provide one or more embodiments of a content transmission system as described herein.

In one or more embodiments, the transmission system operates to scalably transmit content layers to one or more receiving terminals by performing the following steps.
a. The content to be transmitted is scalably encoded to create content layers comprising a base layer and one or more enhancement layers.
b. The base layer is transmitted to all receiving terminals.
c. Each receiving terminal determines whether or not the content is required to be rendered with higher quality than available from the base layer.
d. Receiving terminals that require greater content quality transmit a request to the server requesting additional enhancement layers.
e. The requests for the enhancement layers are received at the server, and in response, the requested enhancement layers are retrieved from a database and transmitted to the requesting terminals.

Thus, the content transmission system performs the above steps to scalably transmit content to one or more receiving terminals. As a result, bandwidth availability and efficiency of the network is maximized since the enhancements layers are only transmitted to those terminals requesting their delivery. Furthermore, the resources of the non-requesting devices are preserved since these devices are not required to store and/or process the enhancement layer data.

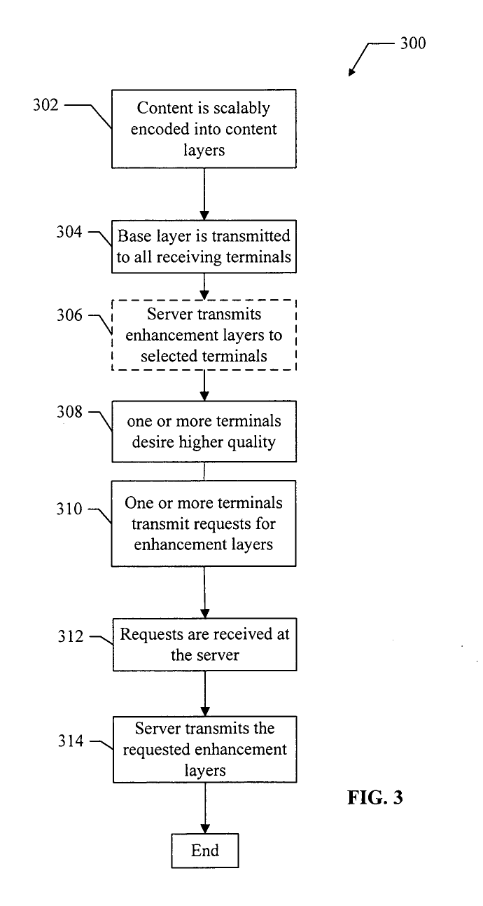

FIG. 3 shows a method 300 that illustrates the operation of one embodiment of a content transmission system. For clarity, the method 300 will be described with reference to the server 102 shown in FIG. 2, and it will be assumed that the content data 206 comprises content to be transmitted to one or more receiving terminals. In one or more embodiments, the server 102 comprises logic (i.e., processing logic 202) operable to execute program instructions stored on computer-readable media to implement the functions described below.

At block 302, content to be delivered from a server to receiving terminals in a data network is scalably encoded. For example, the processing logic 202 comprises encoding logic to scalably encode the content 206 to produce the content layers 208. Any scalable encoding technique may be used to encode the content to form the content layers 208, which comprise a base layer and one or more enhancement layers.

At block 304, the base layer is transmitted to the receiving terminals. For example, the processing logic 202 retrieves the base layer of the content layers 208 and controls the transceiver 210 to transmit the base layer to all receiving terminals. The transmission may be performed as a multicast transmission or as a group of unicast transmissions.

At block 306, an optional step is performed wherein one or more enhancement layers are transmitted to selected receiving terminals based on selected criteria. For example, in one embodiment, enhancement layers are transmitted to terminals based on prior usage (i.e. content consumption, patterns/statistics/data collection, prearranged contracts, and device registration) or based on any other criteria. For example, in one embodiment, enhancement layers are transmitted to selected terminals based on the resources available to the selected receiving terminals. In one embodiment, the processing logic 202 determines that selected criteria have been met and delivers one or more enhancement layers to the one or more selected receiving terminals in a manner transparent to the users of those terminals. Thus, it is possible for a selected receiving terminal to automatically receive enhancement layers without a specific request being made.

At block 308, the receiving terminals receive the base layer for rendering. For example, the base layer allows the content to be rendered with enough quality so that it may be decided at each receiving terminal whether or not it is required to render the content with higher quality. It will be assumed that one or more receiving terminals desire to render the content with greater quality.

At block 310, each receiving terminal that requires the content to be rendered with greater quality transmits a request to the server requesting one or more enhancement layers. For example, in one embodiment, the requests are transmitted over a data network and received by the request receiver logic 214 via the transceiver logic 210.

At block 312, the requests are received at the server and the requested enhancement layers are retrieved from the content layers. For example, the logic 214 receives the requests and obtains the requested enhancement layers from the content layers database 208.

At block 314, the requested enhancement layers are transmitted to the requesting terminals. For example, the logic 214 controls the transceiver 210 to transmit the requested enhancement layers to the requesting terminals.

The operation of the method 300 results in efficient use of network and receiving terminal resources since enhancement layers are only transmitted to requesting terminals. It should be noted that the method 300 illustrates just one embodiment and that changes, additions, or rearrangements of the method steps may be made within the scope of the various embodiments.

### ILLUSTRATED EXAMPLE

The following section provides an example that illustrates how the content transmission system operates to deliver one or more content layers to a large number of receiving terminals. The operation of the content transmission system is compared to a conventional transmission system to show how the content transmission system provides increased network efficiency and services more client devices. In the following example 1k=1024, and 1M=1024*1024.

Once a piece of multimedia content becomes available to a distribution server for the first time, the time period spanning the entire set of unicasts scheduled for that piece of content is an interval during which the shared multi-user communication channel/network is experiencing its peak load. In order to deliver the content to all targeted users with the least amount of latency possible, the communication channel/network is utilized at its full capacity during this “push” phase.

Assume that in a conventional system, an audio-visual content clip having a presentation duration of five minutes becomes available at time (to). This clip is encoded at a total audio (8 kbps) plus video (24 kbps) bandwidth of 32 kbps and hence its size is 9600 kb. The clip has a lifetime of 30 minutes (e.g. a news update), and hence it will expire (i.e. be out-of-date), at time (t₀+30 minutes). Assume also that a delay of at most ⅓ of this lifetime (i.e. 10 minutes) can be tolerated beyond to in order to be considered a timely delivery of this time-sensitive content. If the transmission channel has a bandwidth of 1 Mbps, then the following simple calculation reveals that 64 clients (receiving terminals) can be served in a conventional system under the above given “no more than 10 minutes delay” constraint.
(10 min.×1 Mbps)/9600 kb=600 Mb/9600 kb=(600×1024)kb/9600 kb=64.

In the above, the transmission channel is utilized at its full capacity for 10 minutes starting at time (to) to deliver the content to 64 clients. Without relaxing the maximum permissible delay constraint (associated with time-sensitive multimedia content), one obvious way of increasing the number of clients served is through increasing the transmission channel bandwidth (which is a primary system resource).

However, in one or more embodiments, the described content transmission system operates to provide a unique solution to increasing the number of clients served under the same maximum permissible delay constraint and without requiring any additional system resources (including transmission channel bandwidth), which frequently are additional constraints themselves.

Once a piece of content is delivered to a client device, it is ready for consumption (i.e. being viewed or rendered). User content consumption patterns are such that neither all users/clients view the content immediately upon its availability, nor all pieces of delivered content are viewed in their entirety prior to their expiration, with some delivered content never being viewed before they expire. The first of these two observations, implies that there is “diversity” with respect to the consumption time interval of a piece of content (roughly) spanning the life-time of that content. The second observation implies that under typical conditions, some of the transmission bandwidth, a very valuable system resource, gets wasted due to the delivered but never viewed content segments (partial or entire pieces of content). Thus, in one or more embodiments, the content transmission system operates to achieve the following two objectives.
1. Through exploiting the “time diversity” in the consumption/viewing periods of delivered content and without relaxing the maximum permissible delivery delay constraint, it is possible to smooth-out (i.e. spread over time), the “per-client per-content” transmission budget requirement to provide service to a larger number of clients through a transmission channel (distribution network) of fixed bandwidth.
2. The overall system efficiency can be increased by reducing the percentage of wasted transmission bandwidth.

The content transmission system achieves these two objectives by performing the following.
1. Within the initial time period bounded by the instant of content availability (at the distribution server) and the specified maximum permissible delivery delay, the entire content is delivered to all clients at a lower-than-full quality level still enabling an acceptable presentation quality. Then, rely on content “consumption time diversity” to utilize the remaining life-time of the content to deliver quality-patches (i.e., enhancement layers) to the clients. In this manner, the per-subscriber per-content transmission budget requirement corresponding to content delivery at full-quality is spread over a longer period of time (close to the entire life-time of the content rather than a small fraction of it determined by the maximum permissible delivery latency, e.g. one third of content life-time in the above example). As a result, the content delivery is smoothed out, and therefore enables the distribution server to provide service to a larger number of clients during the peak load interval when the content at its basic quality level, is pushed to all clients.
2. Reduce the deterministically (i.e. for-granted/surely), distributed common representation of the content to a minimal data set enabling an acceptable presentation quality. Reserve the subsequent distribution of quality patches (enhancement layers) to clients actually viewing the content or who are more likely to view it sometime before its expiration. Thus, since only the “for-granted” delivered minimal representation of the content will be wasted for the clients who do not view it, the percentage of wasted transmission budget (bandwidth) will be reduced.

The content transmission system uses a scalable representation of the content to achieve the above stated objectives. In one embodiment, the content transmission system achieves these objectives by performing one or more of the following steps.
1. Maintain the content in the content/distribution server in scalable format.
2. At scheduled unicast/multicast time-frames, transmit to all terminals the content in a basic/preliminary form based on its scalable format (base layer).
3. When a particular subscriber (terminal) wishes to view an extended portion of the content or the entire content, the terminal informs the distribution server through a back-channel (uplink) to provide a refinement to the content, conditioned on the state of the distribution server (i.e. its available resources).

The entire base layer of the scalable representation of the content, possibly appended with an initial (with respect to time) portion of the enhancement layer, provides a basic/preliminary form of the content to be transmitted for-granted to all subscribers. This basic form provides the following.
1. It fulfills the required delivery of a committed piece of content to the subscribers.
2. It enables a preliminary viewing of this piece of content for possible decision making as to whether the content should be viewed for an extended period of time.
3. It provides a basic (satisfactory/acceptable) level of quality for viewing this piece of content in case the distribution server is later not able to provide the (rest of the) enhancement layer to a particular subscriber as a refinement.

For example, taking a typical 1:1 bandwidth ratio between the base and enhancement layers of MPEG-4 Scalable Video, the following approximate upper bounds to the expected performance increase through utilizing one embodiment of the content transmission system can be illustrated as follows.

Assume that the content clip in the present example is encoded again at 32 kbps, but this time in a scalable (both audio and video) format. The individual bandwidths of the content layers are as follows.
video_base: 12 kbps;
video_enhancement: 12 kbps;
audio_base: 4 kbps;
audio_enhancement: 4 kbps.

During operation of the system in accordance with the described embodiments, the distribution server uses only the base layer at an aggregate bandwidth of 16 kbps to deliver a common preliminary representation of the content to all terminals. For example, transmitting five minutes at 16 kbps yields a “per client” transmission budget of 4800 kb. Again, the distribution server has a transmission channel that has a bandwidth of 1 Mbps, which it can utilize for 10 minutes. A very similar calculation to the one made above describes the number of supported terminals as follows.
(10 min.×1 Mbps)/4800 kb=600 Mb/4800 kb=(600×1024)kb/4800 kb=128
This shows that an embodiment of the content transmission system can serve twice the number of clients compared to the conventional system during the peak load interval of the distribution network.

Next, a calculation is made of the percentage of wasted transmission budget (TB) or bandwidth for both cases. Assume that for the considered content type (and delivery time and possibly certain other factors), statistically 10% of the consumer population (as a fraction independent of the actual number of consumers) never view a piece of content during its life-time. The wasted TB due to only partially viewed pieces of content can be easily lumped into this percentage figure and a “percentage wasted TB” can be defined as follows.
wasted TB %=(TB utilized for never-viewed content)×100/(total TB utilized)

In the first case with non-scalable (single layer) content encoding, the “TB utilized for never-viewed content” can be derived as follows.
(TB utilized for never-viewed content)=(TB per user)×(number of users not viewing their content).
Assume that (BW) is the total transmission bandwidth [kbps] available to the distribution server, (AT) is the initial time period [seconds] during which all clients should be delivered the full representation of the content, and (n) is the number of clients. The TB per user can then be expressed as follows.
TB per user=total TB utilized/number of users=BW*ΔT/n
The number of users not viewing their content is equal to (0.10*n ). Then, the “TB utilized for never-viewed content” can be expressed as follows.
TB utilized for never-viewed content=(BW*ΔT/n)*0.10*n=0.10*BW* ΔT
Finally, under the above assumptions, the “percentage wasted TB” for the first (non-scalable content) scenario can be expressed as follows.
wasted TB %=(0.10*BW*ΔT)*100/(BW*ΔT)=10%.

Referring now to the embodiment of the content transmission system using scalable content encoding (base plus one enhancement layer with 1:1 bandwidth ratio) in accordance with the described embodiments, the “TB utilized for never-viewed content” can be expressed as follows.
TB utilized for never-viewed content=(initial “for-granted” TB per user)×(number of users not viewing their content).
Assume that (BW) is the total transmission bandwidth [kbps] available to the distribution server, (ΔT) is the initial time period [seconds] during which all clients should be delivered the preliminary representation of the content, and (2 n) is the number of clients, since the content transmission system can serve twice as many clients as shown earlier under the current example's assumptions. Thus, the initial “for-granted” TB per user can be expressed as follows.
initial “for-granted” TB per user=total initial transmission budget utilized/number of users=BW*ΔT/2 n
The number of users not viewing their content can be expressed as (0.10* 2 n). The “TB utilized for never-viewed content” can then be expressed as follows.

$$\begin{matrix}TB utilized for never \text{-} viewed content = ( BW * Δ T / 2 n ) * 0.10 * 2 n \\ = 0.10 * BW * Δ T\end{matrix}$$

It is interesting to note that as an absolute quantity [number of transmitted bits], the wasted TB in both systems did not change. However, using one embodiment of a content transmission system as described herein, the overall TB utilized (as well as the number of clients served) is larger than in the conventional system as described below.
total TB utilized=total TB utilized initially (for preliminary content representation)+total TB utilized consequently (for quality-patching).
Assuming a 1:1 bandwidth ratio between base and enhancement layers, the “total TB utilized” consequently will correspond to delivering the entire enhancement layer data to all users who view their content. This yields the following result.
0.90* 2 n*(BW*ΔT/2 n)=0.90*BW*ΔT
Lastly, putting all the above together, a “percentage wasted TB” for the embodiment of the scalable transmission system can be expressed as follows.

$$\begin{matrix}wasted TB \% = ( 0.10 * BW * Δ T ) * 100 / ( BW * Δ T + 0.90 * BW * Δ T ) \\ = 10 / 1.9 \\ \approx 5.26 \%\end{matrix}$$

Therefore, based on the stated illustrative assumptions, the embodiment of the content transmission system achieved the following two core advantages over the conventional system.
1. Twice the original number of subscribers can be served during peak load times.
2. The percentage of wasted TB is reduced approximately by half.

With regards to the client device (terminal), the above-described embodiments have a very significant and immediate impact on the utilization of memory resources. Since the received content at the time of its initial scheduled unicast/multicast is at a lower bandwidth, the amount of memory required for its local caching (until its consumption) will be proportionally reduced. This implies that the same terminal can receive and accommodate a larger number of content items for a subscriber's view-or-not decision-making and consumption. Thus, an approximate upper bound to the increase in the available storage capacity at the terminals, based on a 1:1 bandwidth ratio between base and enhancement layers, is that twice as many content clips can be stored at the receiving terminals when using an embodiment of the content transmission system as described herein.

In modern digital communication, transmission/reception, storage, and computation i.e. processing, are the three major contributors to power consumption. Stemming from this fact, various embodiments described herein have immediate positive implications for power efficient communication. As briefly mentioned below, for example in the case of battery-powered (receiving) terminals such as portable telephones, these will lead to extended battery life. During the reception phase, the sufficiency of receiving a reduced amount of initial data i.e. the base layer only, enabled through a particular embodiment, implies reduced presence in the traffic channel i.e. reduced airtime, for the receiving terminal and hence reduced power consumption by its transceiver logic. With respect to data storage, advanced power-efficient memory architectures such as multiple power state memory banks, partial array self-refresh, and an available deep power-down mode, translate a reduction in the amount of necessary data storage i.e. for base layer only, as can be enabled through a particular embodiment of the current invention, to substantial power savings in the memory subsystem of the receiving terminal. Finally, a reduction in the amount of surely processed data and consequently decreased processor activity, in conjunction with power-efficient processor architectures, enable further power savings in the receiving terminal.

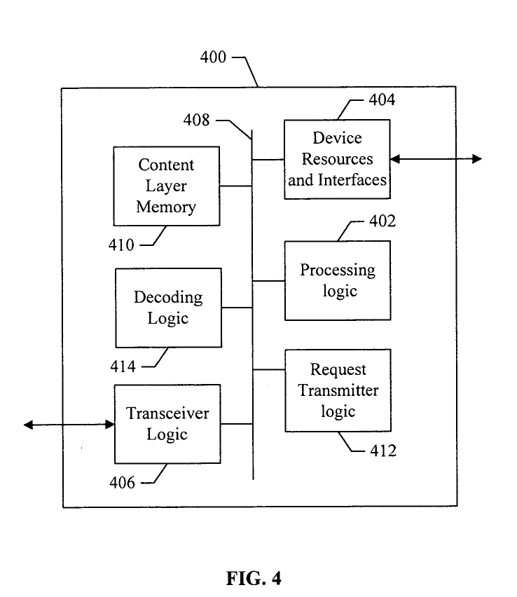

FIG. 4 shows a functional block diagram of a receiving terminal 400 for use in one embodiment of a content transmission system. For example, in one embodiment the terminal 400 is a wireless device, such as a wireless telephone. The terminal 400 comprises processing logic 402, device resources and interfaces 404, content layer memory 410, and transceiver logic 406, all coupled to an internal data bus 408. The terminal 400 also comprises decoding logic 414 and request transmitter logic 412, which are also coupled to the data bus 408.

In one or more embodiments, the processing logic 402 comprises a CPU, processor, gate array, hardware logic, memory elements, virtual machine, software, and/or any combination of hardware and software. Thus, the processing logic 402 generally comprises logic to execute machine-readable instructions.

The device resources and interfaces 404 comprise hardware and/or software that allow the terminal 400 to communicate with internal and external systems. For example, internal systems may include mass storage systems, memory, display driver, modem, or other internal device resources. The external systems may include user interface devices, printers, disk drives, or other local devices or systems. The device resources and interfaces 404 allows the terminal 400 to render content stored in the content layer memory 410.

The content layer memory 410 comprises RAM, ROM, hard disk, FLASH memory, or any type of memory resource that may be used to store content layers. In one embodiment, the content layers are received over a data network from a transmitting server. For example, the content layers may comprise audio, video, or other multimedia content, applications, or data in any format that has been scalably encoded.

The transceiver logic 406 comprises hardware and/or software that operate to allow the terminal 400 to transmit and receive data and other information to/from external devices or systems. For example, the transceiver logic 406 comprises logic to receive data and/or other information over a data network that has been transmitted from other devices, such as content distribution servers. For example, the terminal 400 may use the transceiver logic 406 to receive any number of unicast or multicast transmissions over a data network from one or more content distribution servers. The transceiver logic 406 also comprises logic to transmit information over a data network or to local devices and systems.

The decoding logic 414 comprises any combination of hardware and software that operates to decode content layers received by the terminal 400. For example, in one embodiment, content layers are received at the terminal 400 and stored in the memory 410. The content layers comprise a base layer and one or more enhancement layers that have been scalably encoded. The processing logic 402 controls the decoding logic 414 to decode any or all of the base and enhancement layers to produce decoded content that can be rendered on the terminal 400. For example, in one embodiment, the decoded content is rendered using the device resources and interfaces 404.

The request transmitter logic 412 comprises any combination of hardware and software, and operates to transmit requests to one or more distribution servers to receive encoded content. For example, in one embodiment, the transmitter logic 412 transmits a request to a distribution server via the transceiver logic 406. The request comprises a request to receive one or more enhancement layers from the distribution server. The requested enhancement layers may be used to enhance the rendered quality of a base layer that is already stored at the terminal 400.

When the distribution server responds by sending the requested enhancement layers, the processing logic 402 operates to control the transceiver logic 406 to store the received layers in the memory 410. Once received, the requested enhancement layer can be decoded by the decoding logic 414 to produce decoded content that can be rendered on the terminal 400 with enhanced quality. It should be noted that the terminal 400 is just one embodiment and that additions, changes, deletions, or modifications to the functional elements described may be made without deviating from the scope of the described embodiments.

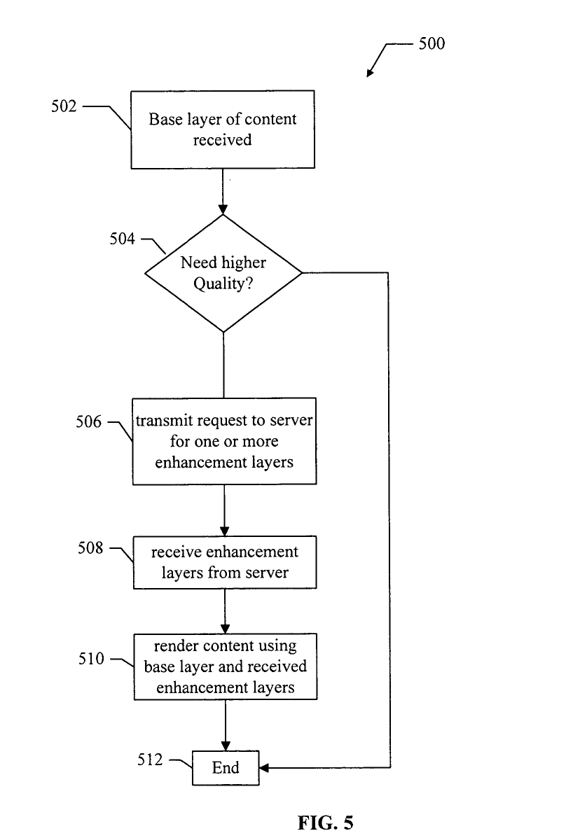

FIG. 5 shows one embodiment of a method 500 for operating a receiving terminal in one embodiment of a content transmission system.

At block 502, a base layer representing the content is received at the device. For example, in one embodiment, a content server, such as server 102, transmits the base layer to the device and it is received by the transceiver logic 406. In one embodiment, the base layer may include, may be coupled with, and/or may be accompanied by a portion or all of one or more enhancement layers.

At block 504, the device has the base layer and may render the content. For example, in one embodiment, the base layer is stored in the memory 410 and rendered on the device by first decoding the base layer with using the decoding logic 414 to produce decoded content, and then rendering the decoded content via the device resources and interfaces 404. If the quality of the content rendered with the base layer is acceptable, or if the device user chooses not to view the content, then no further action is needed and the method proceeds to block 512. If the device user wishes to view the content with increased quality, then the method proceeds to block 506.

At block 506, the device transmits a request to the server to obtain one or more enhancement layers. The requested enhancement layers will allow the content to be viewed with enhanced quality. For example, the request transmitter logic 412 transmits a request to a distribution server via the transceiver logic 406 to request one or more enhancement layers.

At block 508, the device receives the requested enhancement layers. For example, in response to the request for enhancement layers, the server 102, retrieves the enhancement layers from a database and transmits them to the device. The enhancement layers are stored in the memory 410 and used in conjunction with the previously received base layer to render the content on the device. In one embodiment, the received enhancement layers are not stored on the device, and as a result, more services and other noted advantages might be achieved. The decision to store or not store the enhancement layers at the receiving terminal is made by the receiving terminal (i.e., processing logic 402). In another embodiment, the decision to store or not to store is made by the transmitting server. In either case, the decision may be based on a variety of factors that include, but are not limited to, subscription level and/or user preferences.

At block 510 the content is rendered using the base layer and the received enhancement layers. For example, the processing logic 402 controls the decoding logic 414 to decode the base layer and any enhancements layers to produce decoded content that may be rendered on the device with higher quality than just the base layer alone. Thus, the system provides a mechanism that allows receiving terminals to determine the level of quality with which content is rendered.

In another embodiment, based on selected criteria, the device receives the correct number of content layers without having to make a specific request. For example, in one embodiment, enhancement layers are transmitted to terminals based on prior usage (i.e. content consumption, patterns/statistics/data collection, prearranged contracts, device registration) or based on any other criteria. In this embodiment, the distribution server automatically sends the correct number of content layers to the device. Thus, the system also provides a way for devices to receive the specific level of quality they desire without having to make a special request.

The operation of the method 500 results in efficient use of network and receiving terminal resources since enhancement layers are only transmitted to terminals that desire to receive them. Thus, the transmission link to the device is efficiently used and the device's memory resources, processing capability and power are preserved. It should be noted that the method 500 illustrates just one embodiment and that changes, additions, or rearrangements of the method steps may be made within the scope of the various embodiments.

Accordingly, while one or more embodiments of a system for content transmission have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

We claim:

1. A method for transmitting content from a distribution server in a data network, the method comprising:
encoding the content into a base layer and one or more enhancement layers;
transmitting the base layer;
receiving a request for one or more enhancement layers; and
transmitting the one or more enhancement layers.

2. The method of claim 1, wherein said encoding comprises encoding the content into the base layer and the one or more enhancement layers using a scalable encoding technique.

3. The method of claim 1, wherein said transmitting the base layer comprises transmitting the base layer and a portion of the one or more enhancement layers.

4. The method of claim 1, wherein said transmitting the base layer comprises transmitting the base layer and a portion of the one or more enhancement layers based on selected criteria.

5. The method of claim 4, wherein said transmitting the base layer comprises transmitting the base layer and the portion of the one or more enhancement layers based on the selected criteria, wherein the selected criteria is selected from a set of criteria comprising resource availability, prior usage of content, consumption patterns, statistics, prearranged contracts, and terminal registration.

6. The method of claim 1, further comprising:
receiving a plurality of requests wherein each request requests a respective portion of the one or more of the enhancement layers; and
transmitting the respective portions one or more enhancement layers to satisfy the plurality of requests.

7. The method of claim 1, wherein said transmitting the base layer comprises transmitting the base layer over a wireless data network.

8. Apparatus for transmitting content from a distribution server in a data network, the apparatus comprising:
processing logic that operates to encode the content into a base layer and one or more enhancement layers;
transmitting logic that operates to transmit the base layer;
receiving logic that operates to receive a request for one or more enhancement layers; and
logic that operates to transmit the one or more enhancement layers.

9. The apparatus of claim 8, wherein said processing logic operates to encode the content into the base layer and the one or more enhancement layers using a scalable encoding technique.

10. The apparatus of claim 8, wherein said transmitting logic operates transmit the base layer and a portion of one or more enhancement layers.

11. The apparatus of claim 8, wherein said transmitting logic operates to transmit the base layer and a portion of one or more enhancement layers based on selected criteria.

12. The apparatus of claim 11, wherein said selected criteria is selected from a set of criteria comprising resource availability, prior usage of content, consumption patterns, statistics, prearranged contracts, and terminal registration.

13. The apparatus of claim 8, further comprising:
logic configured to receive a plurality of requests wherein each request requests a respective portion of the one or more of the enhancement layers; and
logic configured to transmit the respective portions of the one or more enhancement layers to satisfy the plurality of requests.

14. The apparatus of claim 8, wherein said data network is a wireless data network.

15. Apparatus for transmitting content from a distribution server in a data network, the apparatus comprising:
means for encoding the content into a base layer and one or more enhancement layers;
means for transmitting the base layer;
means for receiving a request for one or more enhancement layers; and
means for transmitting the one or more enhancement layers.

16. The apparatus of claim 15, wherein said means for encoding comprises means for encoding the content into the base layer and the one or more enhancement layers using a scalable encoding technique.

17. The apparatus of claim 15, wherein said means for transmitting the base layer comprises means for transmitting the base layer and a portion of the one or more enhancement layers.

18. The apparatus of claim 15, wherein said means for transmitting the base layer further comprises means for transmitting the base layer and a portion of one or more enhancement layers based on selected criteria.

19. The apparatus of claim 18, wherein said selected criteria is selected from a set of criteria comprising resource availability, prior usage of content, consumption patterns, statistics, prearranged contracts, and terminal registration.

20. The apparatus of claim 15, further comprising:
means for receiving a plurality of requests wherein each request requests a respective portion of the one or more of the enhancement layers; and
means for transmitting the respective portions of the one or more enhancement layers to satisfy the plurality of requests.

21. The apparatus of claim 15, wherein said data network is a wireless data network.

22. A computer-readable media comprising instructions, which when executed by processing logic in a distribution server, operate to transmit content in a data network, the computer-readable media comprising:
instructions for encoding the content into a base layer and one or more enhancement layers;
instructions for transmitting the base layer;
instructions for receiving a request to transmit one or more enhancement layers; and
instructions for transmitting the one or more enhancement layers.

23. The computer-readable media of claim 22, wherein said instructions for encoding comprise instructions for encoding the content into the base layer and the one or more enhancement layers using a scalable encoding technique.

24. The computer-readable media of claim 22, wherein said instructions for transmitting the base layer comprise instructions for transmitting the base layer and a portion of one or more enhancement layers.

25. The computer-readable media of claim 22, wherein said instructions for transmitting the base layer comprise instructions for transmitting the base layer and a portion of one or more enhancement layers based on selected criteria.

26. The computer-readable media of claim 25, wherein said selected criteria is selected from a set of criteria comprising resource availability, prior usage of content, consumption patterns, statistics, prearranged contracts, and terminal registration.

27. The computer-readable media of claim 22, further comprising:
instructions for receiving a plurality of requests wherein each request requests a respective portion of the one or more of the enhancement layers; and
instructions for transmitting the respective portions of the one or more enhancement layers to satisfy the plurality of requests.

28. The computer-readable media of claim 22, wherein said data network is a wireless data network.

29. A method for operating a receiving terminal to receive content transmitted in a data network, the method comprising:
receiving a content base layer;
determining that one or more enhancement layers are required to render the content with enhanced quality;
transmitting a request for the one or more enhancement layers;
receiving the one or more enhancement layers; and
rendering the content using the base layer and the one or more enhancement layers to obtain the desired enhanced quality.

30. The method of claim 29, wherein said rendering comprises:
decoding the base layer and the one or more enhancement layers to produce decoded content, wherein the decoding reverses a scalable encoding technique used to encode the base layer and the one or more enhancement layers; and
rendering the decoded content to obtain the desired enhanced quality.

31. The method of claim 29, wherein said receiving the content base layer comprises receiving the content base layer and a portion of one or more enhancement layers.

32. The method of claim 29, wherein said receiving the base layer comprises receiving the base layer and a portion of one or more enhancement layers based on selected criteria.

33. The method of claim 32, wherein said selected criteria is selected from a set of criteria comprising resource availability, prior usage of content, consumption patterns, statistics, prearranged contracts, and terminal registration.

34. The method of claim 29, wherein said receiving terminal is a wireless device.

35. A receiving terminal that operates to receive content in a data network, the terminal comprising:
means for receiving a content base layer;
means for determining that one or more enhancement layers are required to render the content with enhanced quality;
means for transmitting a request for one or more enhancement layers;
means for receiving the one or more enhancement layers; and
means for rendering the content using the base layer and the one or more enhancement layers to obtain the desired enhanced quality.

36. The terminal of claim 35, wherein said means for rendering comprises:
means for decoding the base layer and the one or more enhancement layers to produce decoded content, wherein the decoding reverses a scalable encoding technique used to encode the base layer and the one or more enhancement layers; and
means for rendering the decoded content to obtain the desired enhanced quality.

37. The terminal of claim 35, wherein said means for receiving the content base layer comprises means for receiving the content base layer and a portion of one or more enhancement layers.

38. The terminal of claim 35, wherein said means for receiving the base layer comprises means for receiving the base layer and a portion of one or more enhancement layers based on selected criteria.

39. The terminal of claim 38, wherein said selected criteria is selected from a set of criteria comprising resource availability, prior usage of content, consumption patterns, statistics, prearranged contracts, and terminal registration.

40. The terminal of claim 35, wherein said terminal is a wireless device.
